(19) United States
(12) Patent Application Publication
(10) Pub. No.: US 2006/0042861 A1
(43) Pub. Date: Mar. 2, 2006

(54) Steering assist mechanism

(76) Inventor: Stanford R. Ovshinsky, Bloomfield Hills, MI (US)

Correspondence Address: ENERGY CONVERSION DEVICES, INC., 2956 WATERVIEW DRIVE, ROCHESTER HILLS, MI, 48309, US

(21) Appl. No.: 10/925,265

(22) Filed: Aug. 24, 2004

(51) Int. Cl. B62D 5/04

(52) U.S. Cl. 180/443

(57) ABSTRACT

In an assist mechanism, a control shaft, manual means for rotating said shaft, a pair of oppositely rotating gears, means for rotating said gears, electrically controlled clutches being normally disengaged, normally open switch means in the circuits of said clutches, means responsive to a predetermined torque applied to said manual means for closing one of said switches and engaging its corresponding clutch, whereby one of said gears drives said control shaft in a direction aiding the turning effort, and means for opening said switch upon a decrease in torque below said predetermined amount.

### FIELD OF THE INVENTION

This invention relates to steering assist mechanisms, and more particularly to mechanisms for vehicles or other devices requiring physical effort to steer or drive. The invention is applicable for power assistance during turning to such devices as tractors, passenger cars, trucks, busses, cranes, agricultural combines, power shovels, material handling equipment, earth moving equipment, aircraft controls and marine applications.

### SUMMARY OF THE INVENTION

It is an object of the present invention to provide an improved power steering assist mechanism which is electrically controlled and serves to supply a variable amount of torque assist to the steering linkage in accordance with the turning effort demanded by resistance such as the road resistance of an automotive vehicle.

It is another object to provide an improved power steering assist mechanism which has a compact arrangement of parts and can be manufactured as a package unit for installation in conventionally-steered vehicles, which has an inherent feedback function, may be conveniently placed into or out of operation, and need have no hydraulic connections or hydraulically actuated elements.

It is a further object to provide an improved power steering assist mechanism of the above nature which may be driven by electrical means independent of the vehicle engine, so that power assistance can be supplied to the steering linkage even upon failure or stalling of the engine, or may be driven by a power take-off directly from the engine or by other sources of rotary power.

It is also an object to provide an improved power steering assist mechanism of the above character, which may be installed at various points in the steering linkage or on the steering shaft itself, and which may utilize a unidirectional or a reversible motor.

It is another object to provide an improved power steering assist mechanism of the above nature, which includes means for predetermining the strength of the applied power assistance, thereby allowing the individual operator to choose the proper rate of power assistance according to his or her needs.

It is further object, in one form of the invention, to provide an improved power steering assist mechanism of the above nature, in which electrical means are provided to vary the torque applied by the power assist means to the driven member of the steering system simultaneously with variations in the manual torque and at a rate proportional to the manually applied torque.

It is also an object, in one form of the invention, to provide a power steering assist mechanism having the above characteristics, in which electromagnetically actuated clutches are utilized to connect the power means with the steering linkage, so that the applied torque may be varied by adjusting the degree of energization of the clutches.

It is a further object to provide a power steering device of the above nature which is capable of use with different types of electromagnetically actuated clutches such as friction clutches and magnetic particle clutches and in which the clutches may be energized to some degree at all times so as to minimize the time delay in initiating power actuation.

It is a further object, in one form of the invention, to provide a power steering assist mechanism having the above characteristics, in which means are provided for energizing the electromagnetically actuated clutches as any desired function, whether linear or non-linear, of the manual torque exerted by the operator.

It is also an object to provide an improved power steering mechanism of the above nature in which the operator is al all times capable of applying manual torque to the steering linkage in addition to the power actuation, so that when the torque limit of a clutch is exceeded additional manual turning effort may be applied to the linkage.

Other objects, features, and advantages of the present invention will become apparent from the subsequent description, taken in conjunction with the accompanying drawings.

### BRIEF DESCRIPTION OF THE DRAWINGS

FIG. 1 is a schematic view of one embodiment of assist mechanism applied to the steering linkage of an automotive vehicle, showing its connection to the steering linkage and also showing the electrical circuits;

FIG. 2 is a side cross-sectional view of a suitable embodiment of the drive and clutch portions of the assist mechanism, showing the arrangement of the gears and magnetic clutches;

FIG. 3 is a bottom plan view of the assembly shown in FIG. 2, parts being broken away for clarity and showing the arrangement of the motor shaft;

FIG. 4 is an end elevational view of the construction of FIGS. 2 and 3, taken in the direction of the arrow “4” of FIG. 2, showing the relation of the motor and main shafts;

FIG. 5 is a fragmentary elevational view in cross-section taken along the line 5-5 of FIG. 6, of one form of switch for controlling the assist mechanism, the switch being mounted on the steering column;

FIG. 6 is a top plan view of the switch shown in FIG. 5;

FIG. 7 is a side elevational view of a driving unit of the type shown in FIGS. 2, 3 and 4 mounted on a vehicle steering column;

FIG. 8 is a schematic view showing a second embodiment of the invention in which a modified form of driving unit is used, and in which the control means for the clutches comprises a rheostat sensitive to changes in the manually applied torque;

FIG. 9 is a side elevational view of a suitable construction of the rheostat control means shown in FIG. 8;

FIG. 10 is a cross-sectional view taken along the line 10-10 of FIG. 9 and showing the mounting means for the rheostat on the steering column as well as the resilient means for transmitting manual torque from the steering wheel to the steering column;

FIG. 11 is a cross-sectional view taken along the line 11-11 of FIG. 9 and showing the gear sector or rack secured to the steering wheel for actuating the rheostat;

FIG. 12 is an elevational view taken in cross-section of a suitable driving unit to be used in the embodiment of FIG. 8 having magnetic particle type clutches;

FIG. 13 is a schematic perspective view showing a method of furnishing power to a driving unit being of the type shown in FIG. 12;

FIG. 14 is an enlarged detail view of the connection of the driving unit in FIG. 13 to the steering column; and

FIG. 15 is a schematic view of another embodiment of the invention in which the rheostat clutch control is combined with a motor of the reversible type.

### DETAILED DESCRIPTION OF THE INVENTION

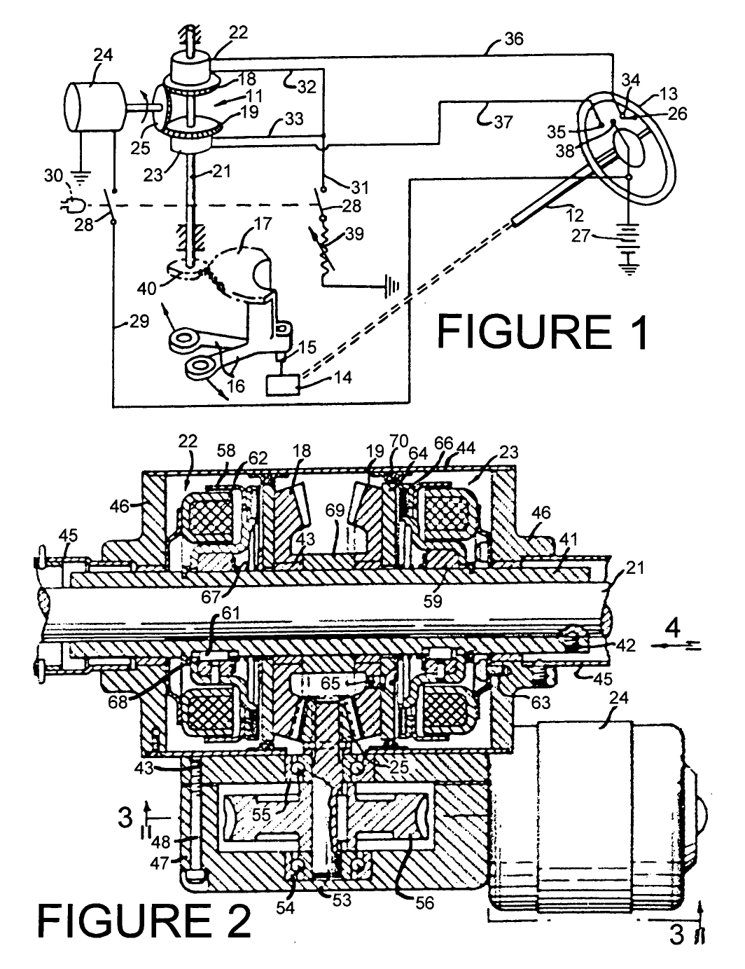

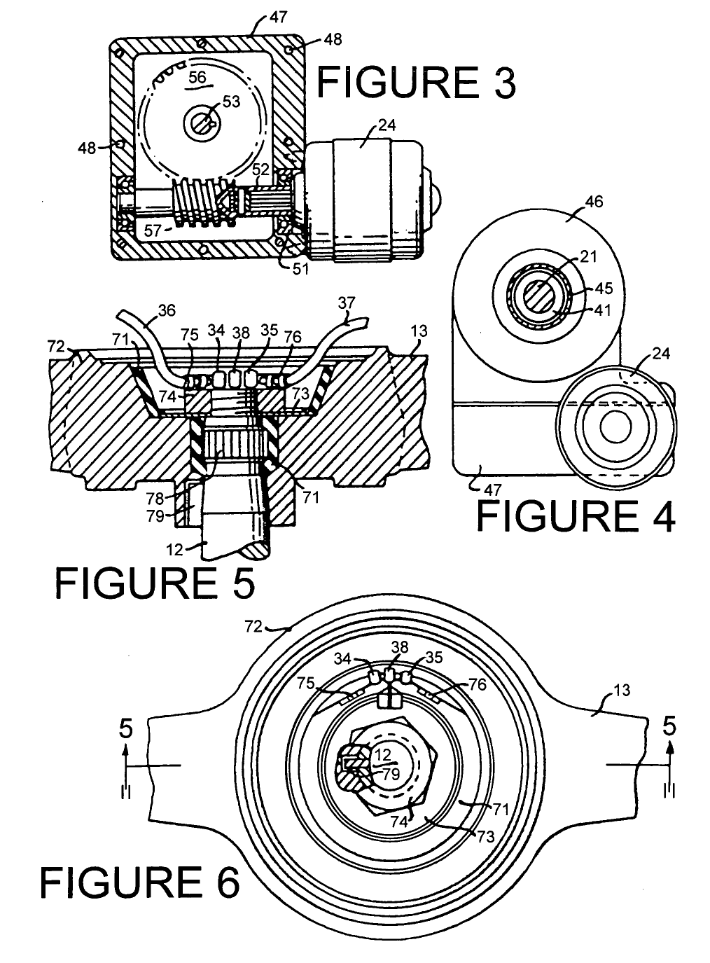

Referring to the embodiment of FIGS. 1 to 6, and more particularly to the schematic showing of FIG. 1, the invention comprises in general a power assist driving means generally indicated at 11 which is drivingly connected to the steering linkage normally controlled by steering column 12 having steering wheel 13. The steering column is shown as connected through a gear reduction unit 14, which may be of the gear and sector type, to a cross shaft 15 having pitman arms 16 secured thereto. The steering assist driving means is adapted to assist the turning effort through a gear section 17 secured to cross shaft 15. It will be understood however that the steering assist driving means could be connected to another portion of the steering linkage, for example to the steering column 12 itself, within the scope of the invention.

The steering assist driving means includes a pair of coaxial oppositely rotating gears 18 and 19 which normally freely rotate on an assist shaft 21, but which are adapted to be alternately clutched to said shaft be means of magnetic clutches 22 and 23 respectively. These clutches may be of any suitable construction, including electromagnetic construction, and are preferably of a type transmitting variable torque up to a predetermined limit. The gears are driven by an electric motor 24 which is of a unidirectional type and rotates a drive pinion 25, and the clutches are energized by the closing of a switch arrangement generally indicated at 26 which is responsive to resistance in the steering linkage when the steering wheel 13 is manually rotated. In other words, the pitman arms 16 are normally controlled solely by steering wheel 13 through the conventional gear reduction drive, and the power assist only comes into play when a predetermined road resistance is encountered by the steering linkage.

Motor 24 may be powered for example by the vehicle battery 27 or other electrical power source, and its circuit is controlled by an on-and-off switch 28, this switch being in circuit leg 29 leading from the positive battery terminal to the motor, the other side of the motor circuit being connected to battery through ground. The position of switch 28 may be controlled by the position of vehicle ignition switch 30 shown in dotted lines, to disconnect the motor when the ignition is off. If desired, suitable electrical controls (not shown) of a conventional nature may be installed in the power supply circuit of the motor to permit its operation at the proper speed when the battery voltage has been temporarily reduced, and to cut out the motor in case of impending damage to the battery. Electromagnetic clutches 22 and 23 are connected to ground through a conduit 31 and branch connections 32 and 33 leading to clutches 22 and 23 respectively. Switch 28 also may control to opening of this circuit as shown to disconnect the clutches when the ignition is off. Normally disengaged contact 34 of switch 26 is connected to clutch 22 and normally disengaged contact 35 is connected to clutch 23, these connections being be means of leads 36 and 37 respectively, and the circuit is completed to either clutch by central contact 38 connected to the positive side of battery 27. Inserted in conduit 31 is a variable resistor 39, preferably mounted in such position as to be operator-controlled, by which means the amount of current flowing through the electromagnetic clutches and their subsequent clutching effect may be varied. Shaft 21 is connected with the steering linkage through a pinion 40 which meshes with gear sector 17.

In describing the operation of the mechanism shown in FIG. 1, it should be kept in mind that contacts 34 and 35 are normally both disengaged, but that one or the other is engaged upon the application of a predetermined turning torque on steering wheel 13. This turning torque is transmitted to the steering column from the wheel through a flexible coupling, not shown in FIG. 1 but illustrated in FIG. 5, and an additional positive lost-motion connection may also be provided between the wheel and column as illustrated in FIGS. 5 and 6 for safety purposes. The functions of the flexible coupling and additional lost-motion connection are described later in detail, the present description concerning itself with the coaction of the switch arrangement, the driving unit and the steering linkage.

The operator first closes switch 28 setting motor 24 in operation and enabling the clutch circuits, so that gears 18 and 19 rotate freely and continuously in opposite directions on shaft 21. Upon turning the steering wheel 13 in either direction, if too little steering resistance is encountered to engage contacts 34 or 35, pitman arms 16 will be moved in the conventional manner through gear reduction unit 14, and gear sector 17 will cause shaft 21 to idle freely through its connection with pinion 40. Should steering resistance be encountered which is sufficient to close contacts 34 and 38, current flowing through lines 31, 32 and 36 will energize clutch 22 causing gear 18 to be clutched to shaft 21, and pinion 40 will drive gear sector 17 in the direction in which the manual effort is being applied. Upon the attainment of a stable steering condition, that is, one in which the manual effort required to hold the linkage in position is below the predetermined amount, contacts 34 and 38 will open as later described in detail and gear 18 will be declutched from shaft 21. In actual operation of course gear 18 may under certain conditions be clutched and declutched with respect to shaft 21 several times in the course of a continuous turning movement of steering wheel 13, depending on the momentary forces in the steering linkage. A similar situation obtains of course with respect to the closing of contacts 35 and 38 and clutching of gear 19 when turning in the opposite direction.

It should be noted that the arrangement of FIG. 1 is such as to automatically compensate for various amounts of road resistance which are encountered in normal driving, and to proportion the amount of steering assistance in accordance with each driving requirement. For example, let us suppose that the contacts 34 and 35 are adjusted to be engaged by contact 39 when the manual effort at the rim of the steering wheel is three pounds, and that the power assist mechanism then comes into operation. At times when the required steering effort is very high, for example when parking, the percentage of steering effort supplied by the assist mechanism is relatively high. If for example the total manual rim effort at the steering wheel would be thirty pounds without the assist mechanism, the latter will supply twenty-seven pounds, or ninety percent of the effort. On the other hand, in situations where the total required steering effort is light for example when traveling at considerable speeds on smooth pavement, the assist mechanism contributes only a small percentage of the total steering effort. For example, if the total effort required were six pounds, the steering assist mechanism would supply only three pounds, or fifty percent. It will thus be seen that in situations where road “feel” is required such as when traveling at considerable speeds, the assist mechanism will automatically adjust its proportionate share of assistance to maintain the operator's feeling of control at the steering wheel. It should also be observed that the inherent slipping characteristics of the electromagnetic clutches will also contribute to the automatic adjustment of the power assist mechanism to variations in load.

The presence of variable resistor 39, it should be noted, lends added flexibility to the system, since the clutching force and hence the steering assistance may be varied at all times to suit the particular driving conditions. Moreover, the device may be conveniently placed out of operation when only manual steering is required, merely be opening manual switch 28. The electrical arrangement is such that the system will be “fail safe”; that is, should lines 36 or 37 be grounded the clutch circuits will not be completed with the possibility of loss of vehicle control. It should also be noted that the power steering mechanism in no way interferes with the normal function of the steering linkage in returning of its own accord to a straight-ahead position when a turn is completed. In this situation the operator either allows the steering wheel to rotate freely or urges it slightly in one direction or the other; contacts 34 and 35 will therefore remain disengaged and the steering assist mechanism will not come into play. It should also be observed that when the road wheels encounter obstacles tending to deflect them from their path, the assist mechanism will come into play to maintain the wheels on course. With the operator resisting such deflecting force at the steering wheel, either contact 34 or 35 will be engaged, and the assist mechanism will further counteract the effect of the obstacle.

FIGS. 2, 3, and 4 illustrate a suitable construction of the driving unit for the power assist mechanism, although it will be understood that other types of constructions could be used within the scope of the invention. The oppositely rotating driving gears 18 and 19 are shown as of bevel type and are driven by bevel driving pinion 25. If desired, bevel gears of the “Zero” type, or other gears designed to minimize thrust loads on the bearings, may be used. Gears 18 and 19 are rotatably mounted on shaft 21 which is rotatably supported by means (not shown) on the chassis of the vehicle. The particular mounting means includes a sleeve 41 secured to shaft 21 by set screw 42, gears 18 and 19 being rotatably supported on sleeve 41 by bearings 43.

A housing 44 encloses gears 18 and 19 as well as magnetic clutches 22 and 23, the housing being coaxial with shaft 21 and supported at its ends by sleeves 45 attached to end hubs 46 of the housing. A motor and gear support housing 47 is secured to one side of housing 44 be means of bolts 48 and an intermediate bearing support 49 for pinion 25, the latter being disposed between housings 44 and 47. Motor 24 is secured to one side of housing 47, the latter supporting a bearing 51 for the motor shaft which includes a flexible coupling 52. Pinion shaft 53 is supported at one end by a bearing 54 in housing 47 and at an intermediate point by bearing 55 within support 49. This shaft carries a worm wheel 56 which is driven by worm 57 on the motor shaft, and thus drives pinion 25.

The magnetic clutches 22 and 23 include rotors 58 outwardly of the driving gears having hubs 59 keyed at 61 to sleeve 41, and annular fields 62 secured to housing end hubs 46 by bolts 63. Fields 62 are adapted to attract armatures 64, which are secured to gears 18 and 19 by bolts 65, toward to frictional faces 66 carried by rotors 58. Springs 67 are disposed between hubs 59 of the rotors, which are held against axial movement by snap rings 68, and armatures 64 of gears 18 and 19. These springs therefore urge the armatures away from their respective rotors 58, gears 18 and 19 engaging a central thrust bearing 69 for positioning purposes. The outer edges of armatures 64 engage seals 70 held by housing 44 to prevent lubricant leakage from the area of the gears. It should be noted that if desired the entire housing may be filled with oil, in which case seals 70 may be dispensed with.

In the operation of the driving mechanism of FIGS. 2, 3 and 4, it will be seen that when motor 24 is energized pinion 25 will continuously drive gears 18 and 19 in opposite directions. With fields 62 de-energized, springs 67 will urge armatures 64 and their respective gears 18 and 19 away from engagement with frictional faces 66 of clutch rotors 58. The latter, being keyed to sleeve 41 which is connected to the steering linkage by shaft 21, pinion 40 and sector 17 as shown in FIG. 1, will move in accordance with movement of the steering linkage. Upon energization of one side or the other of switch 26 during manual turning of the steering wheel, the corresponding armature 64 will be attracted into engagement with friction face 66 of one of the rotors 58. This movement is of course so slight as to maintain the driving engagement between pinion 25 and the gear which is moved. The latter will therefore drive rotor 58 and shaft 21 in a direction of rotation which will aid the steering movement. When sufficient aid has been given to reopen the closed side of switch 26, field 62 will be de-energized and spring 67 will return armature 64 to its disengaged position.

FIGS. 5 and 6 show one embodiment of the switch means for controlling the circuits to electromagnetic clutches 22 and 23, it being understood that other types of switch controls could be utilized within the scope of the invention. Since the steering assistance in the embodiment of FIGS. 1 to 6 is to be given only after a predetermined amount of steering effort has been exerted by the operator, the contacts are arranged to be closed when the torque applied to the steering shaft exceeds a predetermined amount. For this purpose the steering wheel 13 is provided with a terminal insert 71 secured to the hub 72 thereof, and this annular insert carries a pair of contact terminals 34 and 35 corresponding to those with similar reference numerals in FIG. 1. The central contact terminal 38 is disposed between contacts 34 and 35 and in spaced relation thereto, the central contact being secured to steering column 12 by means of a terminal washer 73 and a nut 74 threaded on the end of column 12. Contacts 34 and 35 have clips 75 and 76 for connecting leads 36 and 37 thereto, and terminal washer 73 is grounded, so that contact 38 is connected to ground as shown in FIG. 1.

A yieldable connection is provided between steering wheel 13 and steering column 12 so that contact 38 may engage contacts 34 or 35 upon the attainment of a predetermined torque on the steering column. In the present embodiment, this resilient means includes a flexible coupling 77 which is of annular shape and is secured to hub 72 of the steering wheel on its outer surface and the splined portion 78 of steering column 12 on its inner portion. It will therefore be seen that when steering wheel 13 is rotated, assuming steering column 12 is held stationary by the road resistance, either contacts 34 or 35 will be rotated into engagement with contact 38 secured to the steering column, and the circuit to one of the electromagnetic clutches will be closed to set the steering assist mechanism into operation. When the steering linkage is drive thereby, column 12 will be rotated so as to move contact 38 out of engagement with its mating contact, and it will therefore be seen that the system inherently includes a feedback mechanism for constantly resetting the control switch.

It will be noted that ordinarily the manual torque is transmitted from the steering wheel to the steering column through flexible coupling 77. However, an additional positive lost-motion connection may be provided for safety purposes, and this means includes a lost-motion key-and-slot connection 79 between the steering wheel hub and steering column 12. With this connection, the driver can furnish additional turning effort to the steering linkage after the torque limit of clutches 22 or 23 has been reached, and the lost-motion connection permits operation of switch assembly 26 while preventing damage to the switch parts. A drive release mechanism (not shown) such as that discussed below with respect to FIG. 13 may be installed if desired between motor 24 and the driving unit, so that in the event the steering linkage is actuated manually, with a clutch engaged, at a faster rate than the motor is rotating, the latter will not impose a drag on the system.

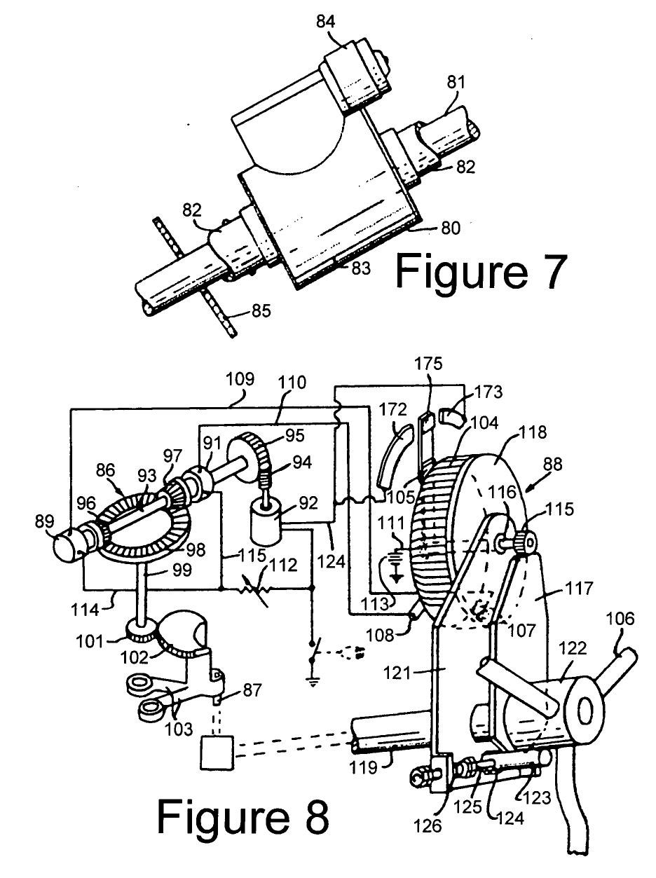

As indicated previously, the driving unit of the power assist mechanism may be mounted on the steering column itself, and FIG. 7 illustrates this type of mounting. The driving unit is indicated generally at 80, with the steering column 81 corresponding in its driving function to shaft 21 in FIG. 2, and covers 82 for the steering column are the equivalent of sleeves 45 in the previous embodiment. The housing 83 of the driving unit is supported by covers 82 and supports motor 84. Preferably, the driving unit is located adjacent the floorboard 85 of the vehicle, and it will be noted that this arrangement results in a minimum of extra parts required for its installation.

FIG. 8 illustrates schematically a second embodiment of the steering assist mechanism which is generally similar in operation to the first embodiment but which utilizes a somewhat different type of driving unit and has additional means for instantaneously varying the clutch engaging force with changes in applied manual torque. The mechanism, which is shown in simplified form in FIG. 8, comprises a driving unit generally indicated at 86 which is connected to the cross shaft 87 of the steering linkage in the same manner as before, and a rheostat assembly generally indicated at 88 which controls the clutches 89 and 91 of the driving unit. Although the driving unit is described in detail later, it may be here stated that it includes a continuously driven motor 92 which drives a shaft 93 through a worm 94 and worm wheel 95. Driving pinions 96 and 97 are rotatably mounted on shaft 93, the connection between these pinions and the shaft being controlled by clutches 89 and 91 respectively. Either of these pinions when driven by shaft 93 actuates an output gear 98, the pinions and gear being shown as of bevel construction. Output gear 98 is secured to shaft 99 which through a pinion 101 and gear sector 102 drives cross shaft 87, pitman arms 103 being attached to the cross shaft. Of course, driving unit 86 could also be installed on the steering column of the vehicle, such an installation being shown in FIGS. 13 and 14 and described below.

Clutches 89 and 91 are controlled by a rheostat 104 of the sliding contact arm type, and the position of contact arm 105 of the rheostat is determined by the manual torque applied to steering wheel 106. The terminals 107 and 108 at opposite ends of rheostat 104 are connected to clutches 89 and 91 respectively by conductors 109 and 1 10, and contact arm 105 is connected to battery 113 by conductor 111. The other ends of the clutch coils are connected through a variable resistor 112, similar in function to resistor 39 of FIG. 1, to ground by conductors 114 and 115 respectively, and it will therefore be seen that clutches 89 and 91 will at all times be energized to some extent, regardless of the position of contact arm 105. With the contact arm 105 in its central position as shown in FIG. 8, clutches 89 and 91 will be energized equal amounts, this energization being relatively weak since the current to each clutch must pass through half the turns of the rheostat. If contact arm 105 is swung toward terminal 107, the energization of clutch 89 will increase while that of clutch 91 will decrease. It will therefore be seen that the engaging forces on the clutches may be varied in any desired manner by properly choosing the shape and electrical characteristics of rheostat 104. For example, the clutch energization may be made linearly proportional to angular movement of contact 105, or a nonlinear change may be effected. It should also be noted that since the clutches are at all times energized to some extent, the time delay in reacting to a change in current will be minimized and the power assistance may thus be immediately applied to the steering linkage.

If desired, means may be provided for de-energizing motor 92 when contact arm 105 is in its central position. As shown schematically in FIG. 8, this means includes a pair of spaced curved contacts 172 and 173 concentric with rheostat 104 and connected in parallel on one side 174 of the motor circuit. A contact 175 carried by contact arm 105 and connected to ground engages either contact 172 or 173 when the contact arm is displaced from its central position thereby energizing motor 92. The motor is disconnected when contact 175 is disposed between the curved contacts with the contact arm in its central position.

As shown schematically in FIG. 8, the means for angularly adjusting contact arm 105 in response to manual torque applied to the steering wheel includes a driven pinion 115 secured to shaft 116 which carries contact arm 105, and a rack or gear sector 117 which meshes with and drives pinion 115. The body 118 of the rheostat is secured to steering column 119 by means of a mounting plate 121, so that the rheostat revolves around steering column 119 as a unit, the axes of shafts 116 and 119 shown as being parallel. Gear sector 117 is secured to hub 122 of the steering wheel which is rotatably mounted on steering column 119. A pin 123 is secured by welding or other means to hub 122 at a point radially spaced from the axis thereof, and this pin extends into an aperture 124 in mounting plate 121, the aperture being somewhat larger than the pin to provide a safety lost-motion connection between the steering wheel and steering column. Pin 123 is engageable on opposite sides by a pair of resiliently mounted pins 125 (one pin being invisible in FIG. 8), these pins being carried by mounting plate 121 and urged against pin 123 by springs 126.

In operation, rotation of steering wheel 106 in either direction will be resisted by one of the yieldable pins 125, and if road resistance is encountered there will be a differential in rotating between steering wheel 106 and steering column 119. This relative movement will cause gear sector 117 to rotate angularly with respect to mounting plate 121, and pinion 115 will be rotated on its axis, thus swinging contact arm 105 and energizing motor 92. The amount of such swinging movement of the contact arm will depend upon the amount of compression of the spring 126 being compressed, and this in turn will depend upon the road resistance encountered during turning. It will therefore be seen that the angular movement of contact arm 105 is proportional to the road resistance and thus to the amount of power assistance required.

When arm 105 is moved from its central position toward one of the terminals, say terminal 107, the energizing current to corresponding clutch 89 will be increased an amount depending both on the degree of movement of the contact arm and the electrical characteristics of the rheostat. At the same time the current in clutch 91 will be decreased, although it will be noted that some current still passes through this clutch. Pinion 96 will therefore be driven by constantly rotating shaft 93, the force transmitted from the shaft to the pinion depending upon the degree of energization of clutch 89. It should be observed that since the rheostat is of the sliding type, the application of torque to pinion 96 will be smooth rather than abrupt, so that the power assistance transmitted from output gear 98 to shaft 99, pinion 101, gear sector 102 and pitman arms 103 will not produce a jarring effect on the steering linkage. It is therefore seen that the power assistance is automatically adjusted to be proportional to that required by the road resistance. As indicated above, rheostat 104 may be wound so as to produce a linear relation between steering wheel torque and applied power, or a non-linear relation could be produced by properly choosing the rheostat characteristics.

The inherent feedback function of the steering assist mechanism will be apparent from the foregoing description. When power assistance is applied to the steering linkage from driving unit 86, the steering column 119 is driven in a direction so as to relieve the compression on the compressed spring 126 and to carry mounting plate 121 back to its neutral position so that both clutches 89 and 91 will be equally and weakly energized, and the supply of power assistance will cease. Of course, during an actual turning sequence the parts may continually vary between extreme positions depending upon the momentary forces involved, but at any instant it will be seen that the steering assistance is regulated by the amount of manual effort exerted by the operator.

As either spring 126 is compressed, additional manual turning effort will cause a direct application of torque from the steering wheel to the steering linkage. This is important in view of the torque limiting characteristics of the clutches, since it will be seen that after the maximum torque which the clutches can transmit has been surpassed, additional turning effort may nevertheless be applied to the road wheels by the operator. It should be noted however that there is no inherent looseness in the steering system since the operator uses manual effort to drive the wheels even when a spring 126 is initially compressed. The compression of either spring 126 transmits a turning force to the steering column 119 in addition to causing the power assist mechanism to come into play so that the turning effort applied to the road wheels is always a combination of manual and power sources. The operator thus always has “road fee” and is cognizant at all times of the forces acting on the wheels of the vehicle. Although compression type springs are shown in the illustrated embodiment as the resilient connection between the steering wheel and the steering column, it will be understood of course that other types of flexible couplings could replace these elements. It should also be noted that movement of the rheostat contact arm throughout its range requires no substantial effort per se, since the contact arm is mounted for free pivotal movement. The rate of change of electrical resistance with torque may thus be accurately and conveniently controlled or adjusted by means of the flexible coupling, without having to take into account the effort required to move the resistor parts.

It should be observed that the pre-energization of clutches 89 and 91 has several important advantages in the steering arrangement. As pointed out above, such pre-energization minimized the time lag between the appearance of road resistance in the system and the application of power assistance, and also contributes to the smoothness of application of the power. In prior construction such as that shown in patent on Penrose No. 2,587,377 issued Feb. 26, 1952 for Electric Power Apparatus for Steering and the Like, the clutches are normally de-energized, and the clutch elements must be moved into engagement upon each actuation of the unit. It has been found that a major proportion of current and time is consumed in the initial buildup of the magnetic field and in carrying such electromagnetic clutch parts into operative condition. The present arrangement therefore provides a highly efficient and improved construction, since the clutches are at all times on the threshold of usefulness. In addition, the constant energization of the clutches serves to cause quicker response of the assist mechanism when a road obstacle is encountered tending to deflect the wheels. In such a case the damping effect of the weakly energized clutches will serve to absorb the forces in the steering linkage and minimize the force transmitted to the steering wheel. Furthermore, whatever force differential is set up by the operator's resistance at the steering wheel will be immediately translated into power assistance tending to keep the wheels on course.

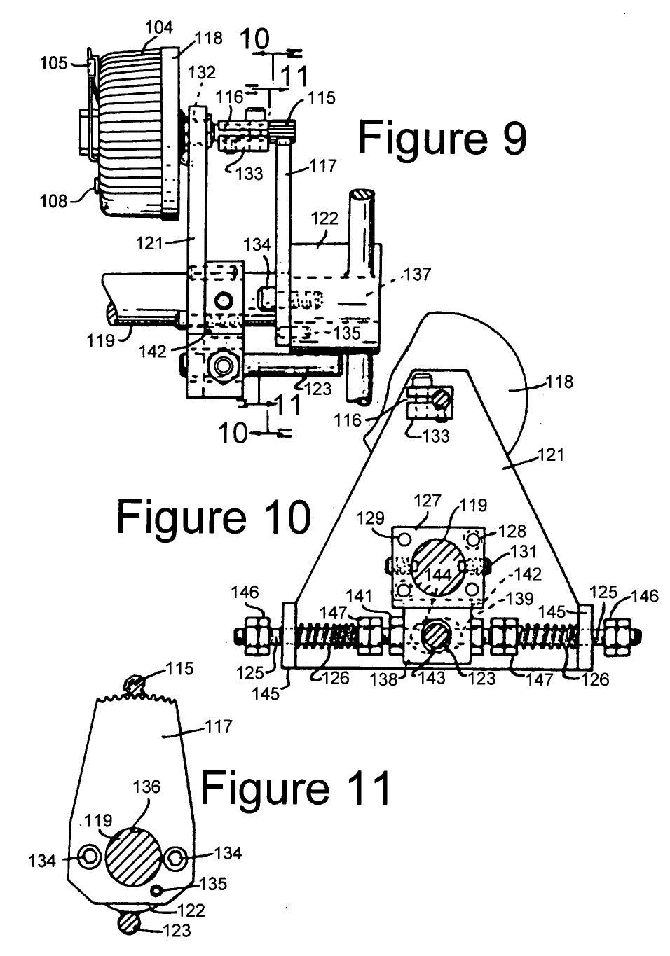

A suitable construction for the rheostat assembly and the resilient connection between the steering wheel and steering column is shown in FIGS. 9-11, these figures omitting the motor switch contacts 172, 173 and 175. It will be understood that other construction are within the scope of the invention, and in particular that a construction could be provided in which the rheostat and contact arm shaft are coaxial with the steering column. It should also be kept in mind that the rheostat assembly could be located at points in the steering linkage other that the juncture of the steering wheel and column. In these figures, the steering column axis is shown as being horizontal for purposes of the drawing, although in an actual installation this axis will normally be inclined. The steering column 119 has mounting plate 121 secured thereto by means of a collar 127 which is secured to the mounting plate by means of bolts 128 and dowels 129, and to the steering column by means of bolts 131. Mounting plate 121 carries rheostat 104 at its outer end by means of a sleeve 132 extending from the rheostat body 118 and fixed to the mounting plate. In some installations it may be desirable to provide slip rings (not shown) or other means of the steering column for connecting the wiring to rheostat 104. The shaft 116 to which contact arm 105 is secured is rotatably mounted within sleeve 132, and pinion 115 is secured to shaft 116 by a coupling 133.

Gear sector 117 is secured to steering wheel hub 122 by means of bolts 134 and dowel 135. The gear sector is provided with an apertured portion 136 for accommodating steering column 119, the latter having an end portion 137 of reduced diameter which rotatably supports hub 122. Pin 123 is secured by such means as welding to the side of hub 122 opposite the teeth of gear sector 117, and extends into a block member 138 is slidable on mounting plate 121 in the direction of the axes of pins 125, and the inner ends 139 of the pins are threadably secured to block 138 and held by lock nuts 141. A dovetail connection 142 between the block 138 and collar 127 holds the block in place during its sliding movement. Pin 123 extends through an enlarged aperture 143 in block 138 and through an elongated aperture 144 in mounting plate 121, the inner ends of pins 125 engaging pin 123. The outer end portions of pins 125 are slidably supported by lugs 145 at the corners of the mounting plate, and are provided with stops 146 shown in the form of lock nuts. Springs 126 are disposed between lugs 145 and stops 147 secured to pins 125, so that when pin 123 is moved in either direction it will compress one of the springs 126 and cause sliding movement of block 138 as well as axial movement of the corresponding pin 125. Stops 147 are preferably of an adjustable nature so that the initial compression of springs 126 and consequently the effort needed to initially slide block 138 may be predetermined.

The operation of the foregoing device will be apparent from the above description. When in its neutral position the counterbalancing effects of springs 126 will maintain pin 123 in a central position with respect to elongated slot 144, and the engagement of pinion 115 and gear sector 117 will therefore be such as to hold contact arm 1 05 in its neutral or intermediate position on rheostat 104. If desired, detent means (not shown) such as a recess may be provided for the central position of contact arm 105 to prevent minor oscillations from affecting its setting. When the steering wheel is rotated by the driver and road resistance is encountered, one of the springs 126 will be compressed, moving pin 123 within elongated slot 144 and causing sliding movement of block 138. Gear sector 117 will thus be angularly rotated with respect to mounting plate 121, and contact arm 105 will be adjusted along rheostat 104 in accordance with the principles described with respect to FIG. 8. The power assistance thus brought into play will cause rotation of steering column 119 in a direction which returns mounting plate 121 to its neutral position with respect to gear sector 117, thereby returning contact arm 105 to its intermediate position. Should a spring 126 be compressed sufficiently to cause pin 123 to engage one end of elongated slot 144 in the mounting plate, further effort exerted on the wheel will cause direct driving of steering column 119 from the steering wheel through pin 123, mounting plate 121, collar 127 and bolts 131 it will thus be seen that provision is made for manual application of effort is excess of the amount available from the power means which is determined by the torque limiting nature of the clutches as described above, this manual effort being exerted through springs 126 and also through the safety lost motion connection should it come into play. It should also be noted that even upon initial compression of a spring 126, manual steering effort is exerted directly on the steering column through the pressure of this spring on lug 145 which is part of mounting plate 121. The spring characteristics are of course so chosen as to permit movement of contact arm 105 at an optimum rate for efficiency of the power steering unit. It should also be observed that due to the fact a clearance exists between pin 123 and enlarged aperture 143, angular movement of the pin around the steering column axis will not result in binding of the parts of the assembly, and that appropriate freedom of movement of the elements is maintained at all times.

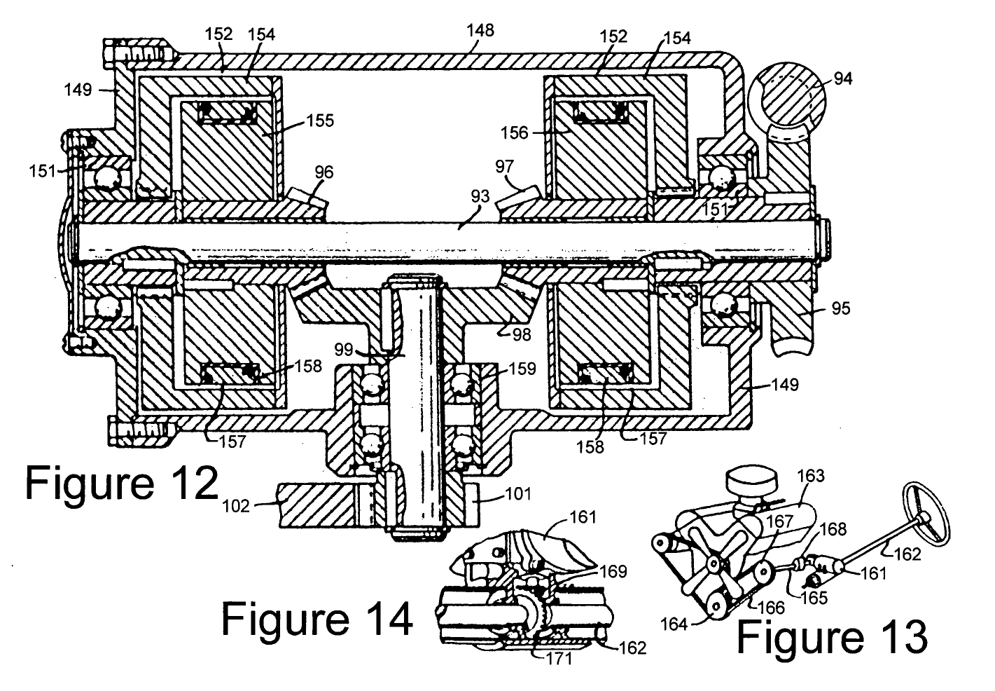

FIG. 12 illustrates in detail the driving unit 86 shown schematically in FIG. 8, it being understood that the invention contemplates the provision of other types of driving units for the purposes described. The unit is shown as enclosed in a housing 148 having end plates 149 which support the continuously rotating shaft 93 by means of bearings 151. Worm gear 95 is secured to one end of shaft 93 and is driven by worm 94 from motor 92, the latter being not visible in FIG. 12. Driving pinions 96 and 97 are rotatably mounted on shaft 93 and are driven from this shaft by means of electromagnetically actuated clutches generally indicated at 152. In the present embodiment, these clutches are shown as magnetic particle clutches having driving members 154 keyed to shaft 93 and driven members 155 and 156 keyed to pinions 96 and 97 respectively. The spaces 157 between the driving and driven members of the clutches are filled with a fluid consisting essentially of finely powdered iron dispersed in a vehicle such as oil, or a dry magnetic powder.

Coils 158 carried by driven members 155 and 156 are connected in circuit with rheostat 104 and the source of electrical power, and when energized these coils cause a magnetic field to pass through the fluid, orienting the particles in such a fashion as to transmit torque from the driving to the driven members. By adjusting the position of contact arm 105 on rheostat 104, an infinite number of torque transmission settings within the range can be effected in each clutch 152, so that the power transmitted through either pinion 96 or 97 to driven gear 98 may be varied. Gear 98 is secured to shaft 99 which is supported by bearings 159 in housing 148, and pinion 101 at the outer end of shaft 99 meshes with gear sector 102 as previously described. It should be kept in mind that clutches other than the magnetic particle clutches illustrated may be used in the driving unit shown in FIG. 2 may be utilized. The magnetic particle clutch however has been found to have very satisfactory characteristics for use in the system described.

As pointed out above, various sources of rotary power, such as vehicle engine take-offs of hydraulic motors, may be used for the driving unit, and FIG. 13 is a schematic view showing a method of supplying rotary power to the driving unit by means of a direct take-off from the engine crankshaft. The driving unit 161 is of the type illustrated in FIG. 12 and is shown as mounted on a steering column 162 as in the embodiment of FIG. 7. The vehicle engine 163 is provided with a pulley 164 rotating a counter shaft 165 through a belt 166 and drive pulley 167. Shaft 165 enters the driving unit 161 and takes the place for example of electric motor 92. It will thus be seen that the power assist steering mechanism may be operated at all times when the engine is running without the necessity of utilizing power from the battery. A drive release mechanism 168 of any known type may be provided between counter shaft 165 and driving unit 161 so that the connection between the counter shaft and driving unit is released when engine 163 is not running, thus permitting free movement of the steering linkage. As shown in FIG. 14, output pinion 169 of driving unit 161 drives a gear 171 mounted on steering column 162.

It should be noted that the variations in engine speed which occur during normal driving conditions will not affect the efficiency of the steering assist mechanism, even if these variations should occur while a power assist steering operation is taking place. This is because of the fact that the energization of the clutches is directly dependent upon the instantaneous amount of effort being exerted by the driver on the steering wheel, so that for example if the applied power is increased due to speeding up of the engine, the clutch energization will be automatically and instantaneously decreased to compensate for this increase in input torque.

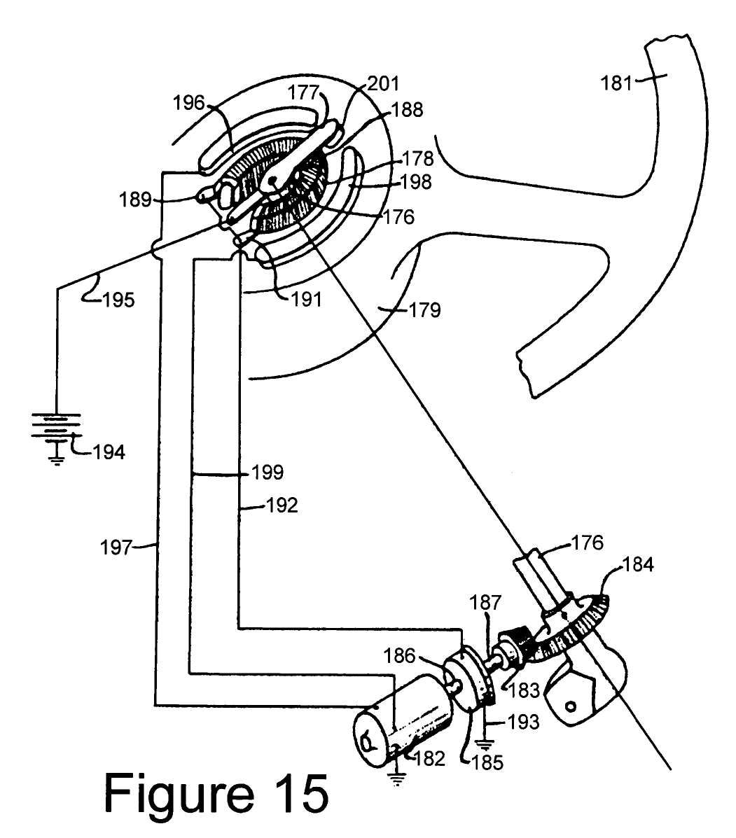

FIG. 15 illustrates schematically another embodiment of the invention in which the rheostat clutch control is combined with a single clutch and a reversible motor. In this embodiment the steering column 176 has a contact arm 177 mounted thereon, and a rheostat 178 is connected to the hub 179 of steering wheel 181, the resilient means connecting the steering column and steering wheel not being shown in this schematic illustration. A motor 182 of a reversible type is connected to steering column 176 by means of a pinion 183 and a gear 184 mounted on the steering column. An electromagnetically operated clutch 185 is interposed between the shaft 186 of motor 182 and the shaft 187 to which pinion 183 is connected. The energization of this clutch is controlled by the position of a contact 188 on contact arm 177 which slides along rheostat 178 in a manner similar to the embodiment of FIG. 8. Both end terminals 189 and 191 of rheostat 178 are connected by a line 192 to one side of the coil of clutch 185, the other side of the clutch coil being connected at 193 to ground. Contact 188 is connected through contact arm 177 to the positive side of an electrical power source 194 by means of a line 195. A curved contact 196 is connected to one field coil of motor 182 by means of a line 197, and a second curved contact 198 is connected to the other field coil of the motor by a line 199. Contacts 196 and 198 are concentric with rheostat 178 and are spaced so that a contact 201 carried by contact arm 177 will be disconnected from both contacts 196 and 198 when the contact arm is in its central position.

In the operation of the embodiment shown in FIG. 15, it will be seen that when contact arm 177 is in its central position, that is, when no manual steering effort is being exerted on steering wheel 181, motor 182 will be de-energized and clutch 185 will be weakly energized due to the central position of contact 188 on rheostat 178. Steering column 176 will therefore receive no power assistance at this time. Should manual effort be exerted on steering wheel 181 in such a direction as to cause counterclockwise movement of contact arm 177 with respect to rheostat 178 as seen in FIG. 15, contact 201 will engage contact 196 to start rotation of motor 182. The direction of rotation of the motor is so chosen as to urge steering column 176 in a direction tending to return contact arm 177 to central position. At the same time, the current passing through the coil of clutch 185 will be increased an amount dependent upon the degree of movement of contact 188 on rheostat 178, due to the lowering of resistance in one of the two paralleled paths of the rheostat which conduct current to line 192. Motor 182 will thus give power assistance to the steering column in an amount proportional to the amount of manual turning effort on the steering wheel, and when contact arm 177 has been returned to its central position motor 182 will again be disconnected and the energization of clutch 185 reduced. Should the steering wheel be manually urged in the opposite direction, contact 201 will engage contact 198 to reverse the rotation of motor 182. At the same time, the energization of clutch 185 will increase in a manner similar to that occurring in the first instance. It is therefore seen that the principles of operation of the rheostat control are equally applicable to unidirectional motors or to reversible motors, the amount of power assistance being varied in each case simultaneously with variations in the manual torque.

While it will be apparent that the preferred embodiment of the invention here in disclosed are well calculated to fulfill the objects above stated, it will be appreciated that the invention is susceptible to modification, variation and change without departing from the proper scope or fair meaning of the subjoined claims.

I claim:

1. In a steering assist mechanism, a steering shaft, a steering wheel on said shaft, a steering linkage operatively connected to said shaft, a pair of coaxial gears, an electric motor for continuously driving said gears in opposite directions, electromagnetic clutching means actuatable between a normal position disconnecting said gears from said steering linkage and a position forming a driving connection between one or the other of said gears and said steering linkage, switch means in the circuits of said electromagnetic clutches, said switch means including a pair of spaced contacts secured to one element of said steering linkage and a third contact disposed between said pair of contacts and secured to another element of said steering linkage, a resilient connection between said steering linkage elements whereby said third contact will engage one or the other of said pair of contacts when said resilient connection is stressed a predetermined amount, and electrical connections between said pair of contacts and said clutches.

2. The combination according to claim 1, said resilient connection connecting said steering wheel and said steering shaft, a source of electrical power connected to said clutches, and a variable resistance inserted in said last mentioned connection, whereby the engaging force of said clutches may be varied.

3. In a steering assist mechanism for a steering shaft having means for manually turning said shaft, an assist shaft, means for forming a driving connection between said shafts, a pair of oppositely disposed gears on said assist shaft, an electric motor for rotating said gears in opposite directions, a pair of electromagnetic clutches adjacent said gears, each of said clutches being operable to engage its corresponding gear with said assist shaft, a pair of switches connected to said clutches, means for normally maintaining said switches in a position disengaging said clutches, and means responsive to the application of a predetermined torque by said manual turning means for moving one or the other of said switches into a position engaging its corresponding clutch, whereby the corresponding gear has a driving connection with said assist shaft.

4. The combination according to claim 3, further provided with a lost-motion positive connection between said manual turning means and said steering shaft, whereby manual torque may be applied to said steering shaft in addition to the torque supplied by said assist shaft.

5. In an electrical control, a pair of coaxial relatively rotatable driving and driven members, a sliding contact rheostat mounted on one of said members said rheostat having a rotatable contact arm resilient means connecting said driving and driven members, movement of said driving member in one direction causing movement of said driven member in the same direction through said resilient means, yielding of said resilient means resulting in relative angular movement of said members, and an actuating element mounted on said other member and connected with said rotatable contact arm to move said arm on the rheostat in response to said relative angular movement of the driving and driven members.

6. The combination according to claim 5, said contact arm normally occupying an intermediate position on said rheostat, the arm being movable from said intermediate position in either direction in response to relative angular movement of said driving and driven members in either direction, the degree of movement of said arm being proportional to the degree of yielding of said resilient means.

7. The combination according to claim 5, said actuating element comprising a gear sector mounted on one of said members, a rotary shaft for said contact arm, and a pinion for said rotary shaft and in mashing engagement with said gear sector.

8. The combination according to claim 5, further provided with a lost-motion connection between said driving and driven members, yielding of said resilient means a predetermined amount causing engagement of said lost-motion connection, whereby further effort applied to said driving member will drive said driven member through said lost-motion connection.

9. The combination according to claim 5, said resilient means comprising a pair of opposed springs carried by one of said members, a portion of said other member extending between said springs, and means for adjusting the resiliency of said springs.

10. The combination according to claim 5, said resilient means comprising a pair of opposed springs carried by one of said members, a portion of said other member being disposed within said springs, and a lost-motion connection between said driving and driven members, said lost-motion connection being taken up when either of said springs has yielded a predetermined amount, whereby further force exerted on said driving member will be transmitted directly to said driven member.

11. In a power assist mechanism, a driving member, a driven member, a rheostat mounted on one of said members and having a contact arm normally in an intermediate position, resilient means connecting said members, movement of said driving member in either direction urging said driven member in the same direction through said resilient means, an actuating element for said rheostat contact arm carried by the other of said members, relative movement between said driving and driven members due to yielding of said resilient means causing said actuating element to move said contact arm from said intermediate position an amount depending upon the degree of yielding f said resilient means, a power assist driving unit including a pair of driving elements, power means for rotating said elements, a pair of electromagnetic clutches for said elements, each of said clutches serving to connect said power means to said driven member through one of said driving elements to urge said driven member in one direction or the other, the amount of torque transmitted by said clutches depending upon the degree of energization thereof, and means connecting said clutches to said rheostat so that when said contact arm is in its intermediate position said clutches are equally energized, movement of said contact arm from its intermediate position causing increased energization of that clutch which will urge said driven member in a direction to restore said contact arm to its intermediate position.

12. The combination according to claim 11, said driving member comprising a steering wheel, said driven member comprising a steering column, said rheostat and actuating element being mounted on said steering wheel and steering column.

13. The combination according to claim 11, further provided with a lost-motion connection between said driving and driven members, yielding of said resilient means a predetermined amount causing said lost-motion connection to be taken up, whereby additional force exerted on said driving member will be transmitted directly to said driven member.

14. The combination according to claim 11, further provided with an electric motor in said driving unit for continuously driving an element in said unit, said clutches serving to connect said continuously driven element with said driven member.

15. The combination according to claim 11, said driving and driven members being in a vehicle and comprising a steering wheel and steering column respectively, and power take-off means from the engine of said vehicle for supplying rotary power to said driving unit.

16. The combination according to claim 11, the electrical characteristics of said rheostat being such that said clutches are both relatively weakly energized when said contact arm is in its intermediate position.

17. The combination according the claim 11, said driving and driven members having a common rotary axis, a mounting plate secured to one of said members, said rheostat being secured to said mounting plate, the contact arm of said rheostat being carried by a rotary shaft in spaced relation with the axis of said driving and driven members, a pinion on said rotary shaft, and a gear sector carried by the other of said members and meshing with said pinion.

18. The combination according to claim 11, said driving unit being further provided with a continuously rotating shaft, said driving elements comprising a pair of pinions rotatably mounted on said shaft, and a gear in constant mesh with both of said pinions and connected to said driven member, said clutches serving to provide a variable torque connection between said shaft and one or the other of said pinions.

19. The combination according to claim 11, said clutches being of a torque limiting type, and a lost-motion connection between said driving and driven members, said connection being taken up when said resilient means yields a predetermined amount, further effort exerted on said driving member being transmitted directly to said driven member through said lost-motion connection, whereby manual effort may be applied to said driven member in addition to the torque transmitted by either of said clutches.

20. In a power assist mechanism, a driving member, a driven member, a rheostat mounted on one of said members, a contact arm for said rheostat connected to the other of said members and normally in an intermediate position on said rheostat, resilient means connecting said members, movement of said driving member in either direction urging said driven member in the same direction through said resilient means, relative movement between said driving and driven members due to yielding of said resilient means causing said contact arm to move from said intermediate position an amount depending upon the degree of yielding of said resilient means, a power assist driving unit including a source of rotary power, means connecting said power source to said driven member for driving said driven member in either direction, and means connecting said last-mentioned means to said rheostat and to a source of electrical power so that when said contact arm is in its intermediate position the connecting means between said power source and said driven member is inoperative, movement of said connection between the power source and driven member to urge said driven member in a direction restoring said contact arm to its intermediate position.

21. The combination according to claim 20, said source of rotary power comprising an electric motor, switch means interposed between said electric motor, switch means interposed between said electric motor and said source of electrical power, and means connecting said switch means to said driving and driven members, said switch means being normally open, relative movement between said driving and driven members causing said switch means to close.

22. The combination according to claim 20, said source of rotary power comprising a reversible motor, said means connecting said power source to said driven member comprising an electrically controlled clutch, switch means interposed between said reversible motor and said source of electrical power, and means connecting said switch means with said driving and driven members, relative movement between said driving and driven members in one direction causing said switch means to close and energize said motor in one direction, relative movement between said driving and driven members in the opposite direction causing said switch means to close and rotate said motor in the opposite direction.

23. The combination according to claim 20, said source of rotary power comprising an electric motor, and an on-and-off switch interposed between said source of electrical power and said motor.

24. The combination according to claim 20, said source of rotary power comprising an electric motor, an on-and-off switch interposed between said source of electrical power and said motor, a vehicle ignition switch, and means connecting said one-and-off switch and said vehicle ignition switch whereby the position of said ignition switch determines the position of said on-and-off switch.
